(19) United States
(12) Patent Application Publication
(10) Pub. No.: US 2022/0317246 A1
(43) Pub. Date: Oct. 6, 2022

(54) SYSTEM AND METHOD FOR AUTOMOTIVE IN-VEHICLE APPLICATIONS USING CASCADED CLASSIFIERS

(71) Applicant: PathPartner Technology Private Limited, Bengaluru (IN)

(72) Inventors: Santhana RAJ, Bengaluru (IN); Dipanjan GHOSH, Bengaluru (IN)

(73) Assignee: PathPartner Technology Private Limited, Bengaluru (IN)

(21) Appl. No.: 17/711,747

(22) Filed: Apr. 1, 2022

(30) Foreign Application Priority Data
Apr. 2, 2021 (IN) 202141015780

(51) Int. Cl. G01S 7/41; G01S 7/02

(52) U.S. Cl. CPC G01S 7/412; G01S 7/023

(57) ABSTRACT

The present disclosure relates to a system (100) for determining occupancy state of objects in a vehicle, the system includes a processor (106) operatively coupled to one or more sensors (102), to process the received set of signals to generate a point-cloud dataset of the received set of signals. A feature generation unit (120) extracts a set of features from the point-cloud dataset and a plurality of classifiers (122) operatively coupled to the feature generation unit to receive the extracted set of features and classify the extracted set of features by cancellation of noise signal generated from the objects within the vehicle, the classification pertaining to any or a combination of existence attributes, occupancy attributes, class attributes and position attributes of living objects to determine the occupancy state of living objects left unattended in one or more zones within the vehicle.

### RELATED APPLICATIONS

This application claims priority under 35 U.S.C. § 119(a) to Indian Patent Application No. 202141015780 filed Apr. 2, 2021, which application is incorporated herein by reference.

### TECHNICAL FIELD

The present disclosure relates, in general, to a sensing system within a vehicle, and more specifically, relates to FMCW radar sensing for classification of objects in the vehicle.

### BACKGROUND

Radar frequency modulated continuous wave (FMCW) technology is nowadays widely used to detect objects of interest within a seat occupancy zone in a vehicle. Occupancy sensors based on radar technology offer advantages like contactless, hidden to users, working in no light condition and can see through thin covers. Existing technology in the field of radar may include a camera-based approach with two levels of classifier, where the first classifier (NN) determines a change of occupant, and an additional classifier determines the change in position of the same occupant.

Another existing technology may include a camera-based approach for in-vehicle applications, where a spatial and temporal feature set is described. It uses a single classifier model to determine the various states of the seats. Another existing technology can include a method to determine the occupancy and other left status based on magnitude component of the reflected signal. It uses entirely a comparison of derived parameters and does not use any classifier. In another existing system, a single deep neural network can be implemented on captured image for classification and extensively describes a probability-based system to determine the child left behind application. However, this system may increase in the computation time to determine the child left behind application.

Another existing system can detect occupancy signal, classification of the occupant, vital signs based on an FMCW radar system. The detection of occupancy is derived from the detected vital signs and the reflected sinusoid signals. Yet another existing system can include a life left behind system that would use an RF system to detect operator outside the car and movement is detected within the car. However, this system cannot determine the life as adult or child and cannot distinguish from the noise cases like shaking car, water bottle, vibration toy/phone and the like.

It is therefore known in the art that radar measurements can be used for various life presence related applications of in-cabin applications. The radar measurement, especially the Doppler measurements are used to determine the breathing and heart rate of the person. Such a system does not require a classifier to determine the child left behind use case. However, these, exemplary existing technologies are prone to inaccurate detection to determine the presence of an occupant and to distinguish the occupant, when other objects move in the vehicle, where the other objects may include engine vibration, shaking car in a bump, moving water bottle jacket and the like. Further, these existing technologies are also prone to delayed response due to the time taken to correctly establish the breathing rate and/or heart rate of the occupant.

Therefore, there is a need in the art to provide a means that can reliably detect child/children/pet left behind anywhere in the vehicle by using a multilevel cascaded approach operating on a strong set of features extracted from the point cloud information of the FMCW radar system.

### OBJECTS OF THE PRESENT DISCLOSURE

An object of the present disclosure relates, in general, to a sensing system within a vehicle, and more specifically, relates to FMCW radar sensing for classification of objects in the vehicle.

Another object of the present disclosure is to provide a system that can cater various in-cabin features

Another object of the present disclosure is to provide a system that can that can break down the complex nonlinear classification problem to a simpler cascaded classification approach, which thereby reduce the requirement of complex deep neural network.

Another object of the present disclosure is to provide a system that operates on distinguishing the noise, false detections and inadvertently provide information about the environment by reliably detecting a child/children/pet left behind anywhere in the whole vehicle.

Another object of the present disclosure is to provide a system that requires less power, computation and memory.

Another object of the present disclosure is to provide a system that can use at least one sensor to cover more than one seat/location, with a minimum of one sensor per seat to a maximum of one sensor per whole car covering two rows, five seats, footwell and truck region

Another object of the present disclosure is to provide a system that can be extended to larger vehicles like 6/7/8 seaters by increasing the field of view of the sensor and/or by adding additional sensors of same type.

Another object of the present disclosure ensures faster response time of less than a second, when compared to other existing radar-based approaches that use vital signs for occupancy detection

Another object of the present disclosure is to provide a system that can be capable to operate under contactless and low ambient light condition.

Yet another object of the present disclosure is to provide a system that can be capable to operate even when the living objects are covered by some materials such as blanket, jacket, sun cover, cloth and the like.

### SUMMARY

The present disclosure relates, in general, to a sensing system within a vehicle, and more specifically, relates to FMCW radar sensing for classification of objects in the vehicle. The present disclosure is to provide a method of the robust child left behind in the vehicle by using the multilevel cascaded approach operating on a strong set of features extracted from the point cloud information of the FMCW radar system, which is capable of reliably detecting the child/children/pet left behind anywhere in the whole vehicle including, but not limited to seats, footwell region and/or trunk region.

The present disclosure relates to FMCW radar system 100 having the signal processing steps of Fast Fourier Transform calculation, removal of static object reflections, and applying the threshold to extract point cloud information. Successively a set of features are extracted from this point cloud information. The features are provided to a first classifier, which determines the presence of any life within the vehicle. If any life is detected, then it is passed on to a second classifier to determine the occupancy status. If any of the seat/zone are identified to be occupied then each zone is passed on a third classifier to determine whether the object is a child or an adult. Depending on the result being adult or child, it then passed on the fourth classifier 130 to determine the out-of-position and activity status. Based on the different results of the four classifiers, the child left behind status can be determined.

In an aspect, the present disclosure provides a system for determining occupancy state of objects in a vehicle, the system including one or more sensors adapted to be placed within the vehicle to generate a set of signals in response to the objects being present in one or more zones within the vehicle, the objects is any or a combination of living objects and non-living objects, a processor operatively coupled to the one or more sensors, the processor configured to process the received set of signals to generate a point-cloud dataset of the received set of signals, a feature generation unit operatively coupled to the processor, the feature generation unit extract a set of features from the point-cloud dataset, the set of features pertaining to a predefined set of frames, and a plurality of classifiers operatively coupled to the feature generation unit, the plurality of classifiers configured to receive, from the feature generation unit, the extracted set of features, classify the extracted set of features by cancellation of noise signal generated from the objects within the vehicle, the classification pertaining to any or a combination of existence attributes, occupancy attributes, class attributes and position attributes of living objects, wherein, based on a combination of classification of the extracted set of features and cancellation of noise signal within the vehicle, the plurality of classifiers is configured to determine the occupancy state of living objects left unattended in one or more zones within the vehicle.

In an embodiment, the plurality of classifiers can include a first classifier, a second classifier, a third classifier and a fourth classifier.

In another embodiment, the first classifier of the plurality of classifiers determines the existence attributes of living object within the vehicle by cancellation of the noise signal generated by the non-living objects within the vehicle. The first classifier can differentiate between living objects and non-living objects.

In another embodiment, the second classifier of the plurality of classifiers is enabled when a confidence level of the first classifier is above a threshold value for the predefined set of frames, wherein the second classifier cancels the noise signal generated by motion of the living objects within the vehicle and determines the occupancy attributes of the detected living objects in one or more zones within the vehicle.

In another embodiment, the second classifier of the plurality of classifiers determines the total number of living objects located in one or more zones within the vehicle. The second classifier differentiate between the motion of living objects and the detected living objects.

In another embodiment, the third classifier of the plurality of classifiers is enabled, when the confidence level of each of the first classifier and the second classifier is above the threshold value for the predefined set of frames, wherein the third classifier, on receipt of an enable signal, configured to determine the class attributes of the detected living objects in a respective zone of the one or more zones within the vehicle, the third classifier differentiate the class attributes of the detected living objects.

In another embodiment, the fourth classifier of the plurality of classifiers is enabled, when the confidence level of the third classifier is above the threshold value for the predefined set of frames, wherein the fourth classifier determines the position attributes of the detected living objects for a particular size of the living objects in one or more zones within the vehicle, the position attributes pertaining to any or a combination of desirable position and out-of-position of the living objects within the vehicle.

In another embodiment, the combination results of the plurality of classifiers are employed individually or in a group for the different in-cabin applications.

In another embodiment, the occupancy state of living objects left unattended in one or more zones within the vehicle are any or a combination of child, infant and pet.

In an aspect, the present disclosure provides a method for determining occupancy state of objects in a vehicle, the method including receiving, at a processor, a set of signals from one or more sensors to generate point-cloud dataset of the received set of signals, the one or more sensors adapted to be placed within the vehicle to generate the set of signals in response to the object being present in one or more zones within the vehicle, the object is any or a combination of living object and non-living object, extracting, at a feature generation unit, a set of features from the point-cloud dataset, the set of features pertaining to a predefined set of frames, the feature generation unit operatively coupled to the processor, receiving, by a plurality of classifiers, the extracted set of features from the feature generation unit, the plurality of classifiers operatively coupled to the feature generation unit; and classify, at the plurality of classifiers, the extracted set of features by cancellation of noise signal generated from the objects within the vehicle, the classification pertaining to any or a combination of existence attributes, occupancy attributes, class attributes and position attributes of living objects, wherein based on a combination of classification of the extracted set of features and cancellation of noise signal within the vehicle, the plurality of classifiers is configured to determine the occupancy state of living objects left unattended in one or more zones within the vehicle.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWINGS

The following drawings form part of the present specification and are included to further illustrate aspects of the present disclosure. The disclosure may be better understood by reference to the drawings in combination with the detailed description of the specific embodiments presented herein.

FIG. 1 illustrates an exemplary representation of a FMCW radar system for determining the occupancy state of objects within the vehicle, in accordance with an embodiment of the present disclosure.

FIG. 2 is an exemplary flow chart illustrating a method(s) to determine the child left behind application in the vehicle, in accordance with an embodiment of the present disclosure.

FIG. 3 illustrates an exemplary top view of the antenna averaged data at a zero degree angle, in accordance with an embodiment of the present disclosure.

FIG. 4 illustrates an exemplary view of the radar mounting position within the vehicle, in accordance with an embodiment of the present disclosure.

FIG. 5 illustrates an exemplary flow diagram of a method(s) for determining occupancy state of objects within the vehicle, in accordance with an embodiment of the present disclosure.

### DETAILED DESCRIPTION

The following is a detailed description of embodiments of the disclosure depicted in the accompanying drawings. The embodiments are in such detail as to clearly communicate the disclosure. If the specification states a component or feature “may”, “can”, “could”, or “might” be included or have a characteristic, that particular component or feature is not required to be included or have the characteristic.

As used in the description herein and throughout the claims that follow, the meaning of “a.” “an,” and “the” includes plural reference unless the context clearly dictates otherwise. Also, as used in the description herein, the meaning of “in” includes “in” and “on” unless the context clearly dictates otherwise.

The present disclosure relates, in general, to a sensing system within a vehicle, and more specifically, relates to FMCW radar sensing for classification of objects in the vehicle. The present disclosure relates to a radar sensor system and a method of operating the radar sensor system to detect child left behind within the interior of the vehicle by using a multilevel cascaded classifier system, where multilevel cascaded classifier system can break down the complex nonlinear classification problem to a simpler cascaded classification approach. The radar sensor can include a transmitter and receiver to transmit and receive the radar signals, a signal processing unit to perform various algorithms like a fast Fourier transform (FFT) and thresholding to extract point cloud information and followed by a feature generation unit to extract multiple of features from the point cloud information and provide it to the multilevel cascaded classifier system to perform various applications that carter to the in-cabin requirements of any automotive vehicle.

The present disclosure aims to provide a system of robust in-cabin solution for a child left behind detection in the vehicle with an FMCW radar system that is implementable in an embedded platform. This system has various other by-products that carters to various features and applications including, but not limited to, life presence detection, seat occupancy detection, adult vs child classification, child/pet left behind detection, seat belt reminder and out of position. One major advantage of this present disclosure is the breakdown of the complex nonlinear classifier problem that is required for the child left behind detection in the vehicle, into cascaded multiple classifiers that are simpler, small and implementable within the constraints of an edge embedded system.

An aspect of the present disclosure is to provide a method of the robust child left behind in the vehicle by using the multilevel cascaded approach operating on a strong set of features extracted from the point cloud information of the FMCW radar system, which is capable of reliably detecting the child/children/pet left behind anywhere in the whole vehicle including, but not limited to seats, footwell region and/or trunk region. The present disclosure can be described in enabling detail in the following examples, which may represent more than one embodiment of the present disclosure.

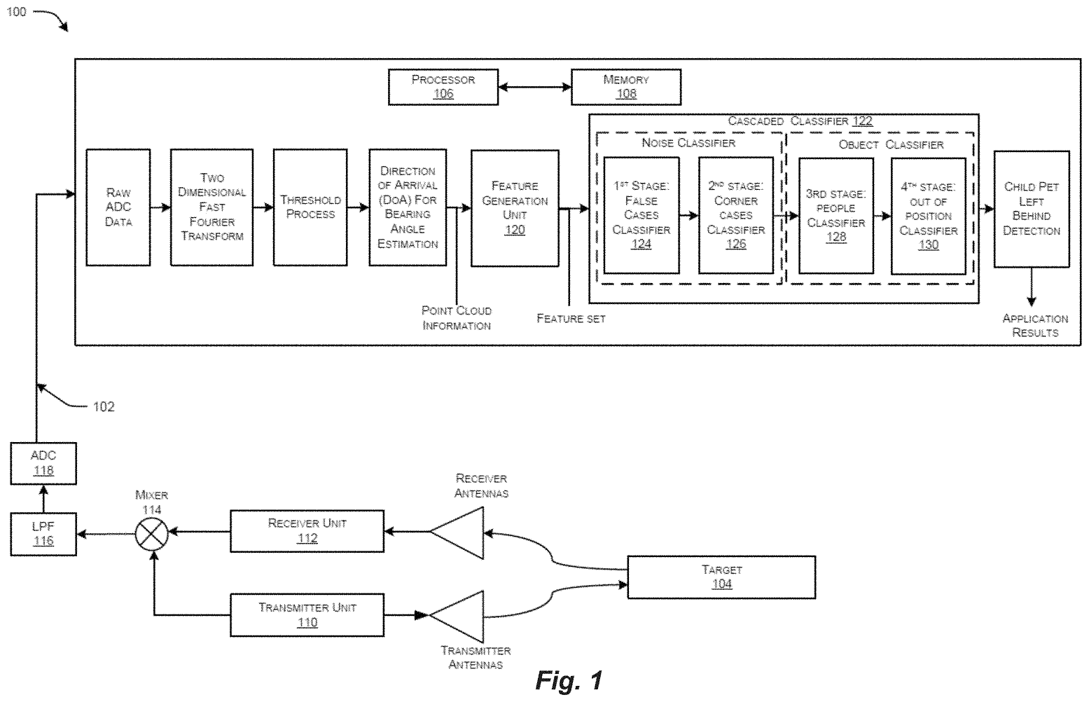

FIG. 1 illustrates an exemplary representation of a FMCW radar system for determining the occupancy state of objects within the vehicle, in accordance with an embodiment of the present disclosure.

Referring to FIG. 1, frequency modulated continuous wave (FMCW) radar system 100 (also referred to as a system 100, herein) may be configured in a vehicle to classify objects 104 in an interior of the vehicle, the system 100 can determine the occupancy state of living objects within the vehicle, where the objects 104 may be living objects such as an adult, child, infant and non-living objects such as water bottle, doll and the like. The objects 104 also interchangeably referred to as targets 104. The occupancy state is a description of the state or condition of one or more occupying items in the vehicle. System 100 may include one or more sensors 102, for example, a radar sensor that may be mounted within the vehicle with its radio frequency (RF) emitting direction pointing towards the interior of the vehicle. The system 100 can include a processor 106, a memory 108, transmitter unit 110, a receiver unit 112, a mixer 114, a low pass filter (LPF) 116, an analogue to digital converter (ADC) 118, a feature generation unit 120, and a cascaded classifier 122. System 100 can classify the objects 104 to determine the life presence detection, seat occupancy detection, adult vs infant/child detection, a child left behind detection, airbag deployment, out of position detection, airbag suppression, automated child lock and the like.

In an exemplary embodiment, the vehicle as presented in the example may be a four-wheeler vehicle, e.g., a car. As can be appreciated, the present disclosure may not be limited to this configuration but may be extended to larger vehicles like 6/7/8 seaters by increasing the field of view (FOV) of the sensors and/or by adding additional sensors of the same type. At least one sensor of the one or more sensors 102 can cover more than one seat/location, with a minimum of one sensor per seat to a maximum of one sensor per whole car covering two rows, five seats, footwell region and truck region The present disclosure ensures faster response time of less than a second when compared to other existing radar-based approaches that use vital signs for occupancy detection.

In an embodiment, one or more sensors 102 may be preferably mounted within the vehicle to generate a set of signals in response to the objects 104 being present/positioned in one or more zones within the vehicle. In another embodiment, different vehicles may require one or more sensor mounting configurations, where the sensor arrangement can be divided into one or more zones. For example, single sensor 102 may cover more than one seat/zone/location in the car covering two rows, five seats, footwell region and truck region, whereas one or more sensors 102 may be used to increase the FOV of the sensor in larger vehicles. The zones can be defined in two-dimension or three-dimensions. The zones can be defined in cartesian or polar coordinates. There can be any number of zones within the vehicle and can overlap in dimensions. The zones can be any or a combination of single cuboid and/or rectangle or a group of multiple cuboids and/or rectangle. The zones specifically show the areas of interest in the point cloud.

In an embodiment, the transmitter unit 110 of the one or more sensors 102 may include at least one antenna to emit high-frequency signals (radar signals) illuminating the interior of the vehicle, the receiver unit 112 may include at least one antenna that may receive the emitted signals after getting reflected on the objects 104. System 100 may use the transmitter unit 110 and receiver unit 112 to transmit and receive the signal frequency in GHz or any required suitable range. In an exemplary embodiment, the system 100 may use a frequency range of 60-64 GHz band, 77-81 GHz band and 24 GHz band and any combination thereof. System 100 may emit the selected radar signals and receive the same signal back after reflecting from object 104, where the reflected signal may include the information specifically about the reflected object. The transmitted and reflected signal is mixed and the intermediate frequency is obtained, which is considered as an input data.

In another embodiment, a mixer 114 may be operatively coupled to the transmitter unit 110 and the receiver unit 112 to combine the signals received from the transmitter unit 110 and the receiver unit 112, the mixer 114 may be operatively coupled to the LPF 116 to obtain the intermediate frequency signal, which may be considered as the input data, where the intermediate frequency signal may include range, velocity and bearing angle information about the reflected object. The received intermediate signal has information from multiple reflections from all objects 104 in the FOV of one or more sensors 102. The ADC 118 may convert the received set of signals to process in a digital domain in processor 106.

The input data may be collected using FMCW radar with any or a combination of single waveform pattern and multiple waveform patterns. In an exemplary embodiment, the waveform pattern may be an up-chirp waveform pattern, with a constant slope. The input data may include one or more samples within the chirp, for more than one chirp and more than one receiver antenna, the input data may be arranged in a cube pattern with samples per chirp in range direction, chirps in doppler direction and antenna in an angular direction.

In an exemplary embodiment, processor 106 may be a signal processing unit. The processor 106 operatively coupled to the one or more sensors 102, where processor 106 configured to process the received set of signals to generate a point-cloud dataset of the received set of signals. In an embodiment, the processor 106 may include a memory 108 for storing the information, where the memory 108 can be part of the processor 106 or can be a separate unit associated with the processor 106 depending upon the application. The processor 106 may receive the digital set of signals from the ADC 118 to extract prominent reflected signals. The processor 106 may process the received digital set of signals (i.e., received set of signals) to generate the point cloud dataset also interchangeable referred to as point cloud information/list of the received digital set of signals using two-dimensional Fast Fourier Transform (2D FFT), thresholding technique, and Direction of Arrival (DoA) algorithm.

The point cloud information is a set of detection points, which represents the reflected signals. The reflected signals are the peaks that are seen in the Fourier transform plots and these are detected by the threshold techniques. The point cloud list has information about the range, angle (azimuth and/or elevation), velocity and/or reflected power of the targets 104 such as adult, children, baby, empty seats and other objects inside the car that are within the FOV of the one or more sensors 102.

In another embodiment, the point cloud information thus generated can be used for feature generation, where the feature generation unit 120 operatively coupled to the processor 106 can extract a set of features from the point-cloud dataset, where the set of features pertaining to a predefined set of frames, which can include mean and/or expectation of values, distribution or spread of values, time-averaged values and variation and/or distribution over time. These features are with reference to the set of detection points within the zone/seat/group, where the zone/seat group can refer to the group of detection points that are from a predefined area within the vehicle. This area can refer to the reflections from any objects present in the single-seat location, single row location, trunk region, footwell region, multiple seats grouped, or the entire car. The area dimensions are already known with respect to the car and the sensor mounting in the car. The area need not be limited to two-dimensions and can be represented in a volume. The present disclosure is not limited by the type of zone/seat grouping. The present disclosure works both with or without zone-based grouping.

In another embodiment, for every frame, the point clouds are grouped with respect to the different zones. The set of features are extracted based on the detection points that fall within each respective zone. In a certain frame, there might be no points within a zone or only one point or plural of detection points. The features thus generated for the entire point cloud list or with respect to specific zones are provided as an input to the classifier stage 122. Any number of features can be extracted from this point cloud information or object list after the zoning. These features can be a group of features extracted from a single frame or multiple past frames or a combination of both. The features can be as simple as the point cloud information itself directly.

In an exemplary embodiment, the classifier 122 can be cascaded classifier 122, where the cascaded classifier 122 can breakdown the highly complex non-linear classification problem, into a simpler cascaded classification approach. The cascaded classifier 122 operatively coupled to the feature generation unit 120, the cascaded classifier configured to receive, from the feature generation unit 120, the extracted set of features. The cascaded classifier 122 can classify the extracted set of features, by cancellation of noise signal generated from the objects within the vehicle, the classification pertaining to any or a combination of existence attributes, occupancy attributes, class attributes and position attributes of living objects. Based on a combination of classification of the extracted set of features and cancellation of noise signal within the vehicle, the cascaded classifier 122 can be configured to determine the occupancy state of living objects left unattended in one or more zones within the vehicle.

In another exemplary embodiment, the cascaded classifier 122 as presented in the example can break down the problem of the child left behind detection, which is a highly complex nonlinear classification problem into two simpler classifiers groups as described below.

Noise removal Classifier:—remove the false cases and the corner cases. This includes:

False cases Classifier—remove non-living false cases like shaking car and water bottle.

Corner Cases Classifier—remove living corner cases like hand movements, lying down and the like

Object Classifier:—classify the living objects after removing the corner cases.

People Classifier (PC)—determine the type of life present.

Out-of-position Classifier (OOP)— Determine the living object as being in out-of-position.

In an embodiment, cascaded classifier 122 can include a first classifier 124, a second classifier 126, a third classifier 128 and a fourth classifier 130. The false cases classifier 124 also interchangeably referred to as the first classifier 124. The corner cases classifier 126 also interchangeably referred to as the second classifier 126. The people classifier 128 also interchangeably referred to as the third classifier 128. The OOP 130 also interchangeably referred to as fourth classifier 130. In another embodiment, the first classifier 124 and the second classifier 126 can be termed as noise removal classifiers and the third classifier 128 and fourth classifier 130 can be termed as object classifiers.

The single problem of the child left behind detection with high accuracy is a complicated nonlinear classifier problem that requires a deep learning (DL) neural network (NN) to solve, where the amount of computation required for such a network can be high and may demand a graphics processing unit (GPU) with a lot of processing power, which thereby increase cost and demanding more power consumption. Since the child left behind detection functionality is expected to work even when the engine is off for long periods of time, running on battery power, it is required to perform this functionality with as much less power as possible. This makes the complex deep neural network-based solution undesirable and makes it requiring workarounds to reduce the power consumption, which may or may not lead to compensation in the functionality.

In an embodiment, the noise classifiers even though operate on distinguishing the noise, also inadvertently provide information about the environment. The first classifier 124 can cancel the noise signal generated by the non-living objects within the vehicle and determines the existence attributes of the living objects (also interchangeable referred to as presence of life) within the vehicle. The noise signal generated by the non-living objects can include false noise cases like water bottle, shaking car, engine on, idling car, moving jacket/coat/dress, analogue clock and the like. The first classifier 124 while trying to remove false noise cases, also classifies any moving object as a living or non-living object. The false cases can be categorised into the non-living object class or the false cases class.

For example, the first classifier 124 can receive the set of features as input to determine the presence of any living object within the vehicle, where the first classifier 124 can differentiate between the living objects and other non-living object and moving objects. The first classifier 124 can determine whether the moving object of interest is a living object e.g., adult, child, pet, infant or any other false cases like water bottle, shaking car, engine on, idling car, moving jacket/coat/dress, analogue clock and the like. The first classifier 124 can determine the presence of any living object within the vehicle based on the inverse relation to the bodily movements of the living object, where the bodily movements can include big movements like talking, laughing or small movements from bio-vitals like breathing, heart rate, blood pulse and the like. These bodily movements can be captured by the radar in the doppler domain and are broadly called as micro doppler information.

The first classifier problem is non-linear and hence requires a nonlinear simple classifier based on machine learning algorithms. The present disclosure describes the first classifier 124 that can include, but not limited to, a support vector machine (SVM). The first classifier 124 determines the positive presence of the living object against the non-living object. This is determined from the confidence value averaged over the predefined set of frames being lower than a threshold value.

Once the first classifier 124 determines the positive presence of life within the vehicle, then the second classifier 126 is invoked to determine the occupancy attributes of the living object within the vehicle. In another embodiment, the second classifier 126 is not invoked if the determination of the first classifier 124 within the vehicle is a non-living object. The second classifier 126 is enabled when the confidence level of the first classifier 124 is above the threshold value for the predefined set of frames, where the second classifier 126 cancels the noise signal generated by the motion of living objects within the vehicle and determines the occupancy attributes of the detected living objects in one or more zones within the vehicle. The noise signal generated by the motion of living objects can include lying down, baby crawling, hand movement in other seats, seat laid down and the like within the seat/zone/row/location. The second classifier 126 can also determine the total number of living objects located within the vehicle. The second classifier 126 differentiate between the motion of living objects and the detected living objects in the one or more zones.

For example, the second classifier 126 approach is to determine the location of the life present within any one of the location/zone/seat group. The groups are predefined for a specific vehicle depending on the requirement or all the possible occupiable positions in the car. This classifier determines the validity of life being present in each of the predefined zone within the vehicle. The identified life can be a single human/pet or a group of human/pet in multiple locations. The second noise classifier 126 distinguishes the corner cases like lying down, baby crawling, hand movement in other seats, seat laid down and the like from the living person within the seat/zone/row/location.

The second classifier problem is also nonlinear and more complex among all the four classifiers described in the disclosure. This is still lesser complex than the deep neural network algorithm that is required to be implemented for the entire child left behind detection system. This present disclosure describes the second classifier 126 that may include, but not limited to, support vector machine (SVM). The result of the second classifier 126 can be determined either directly from the confidence value of the classifier being lower than the threshold, or from the confidence value averaged over the predefined set of frames being lower than the threshold or the result averaged over the predefined set of frames being lower than the threshold. The present disclosure proposes to include, but not limited to, the confidence value averaged over the predefined set of frames as a check to determine the life present in the zone/seat status.

In an example implementation, when the first classifier 124 gives a negative result and detects the moving object as a living object, coupled with the second classifier 126 not detecting any living object in any predefined zones/seats/rows/location, it means that the living object is present in the vehicle which is not covered by the zones/seats and the like. Based on the results of both the noise classifier (124, 126), the object classifiers are invoked to determine the type of the living object. The noise classifiers (124, 126) can successfully remove false cases and corner cases. The third classifier 128 is not invoked when the first classifier 124 has detected a false case and/or when the second classifier 126 has detected a corner case within any of the zone/seat/locations. The third classifier 128 is enabled, when the confidence level of each of the first classifier 124 and the second classifier 126 is above the threshold value for the predefined set of frames, the third classifier 128, on receipt of an enable signal, configured to determine the class attributes of the detected living objects in a respective zone of the one or more zones within the vehicle, where the class attributes of living objects can include adult, kid, teen, infant, or pet.

For example, the third classifier 128 can determine the type/class of state of the living object. It is to be noted that once the false noise cases and corner cases are removed, then the remaining cases can be only of living objects. The third classifier 128 can determine the type of living object detected by the first classifier 124 and the second classifier 126. The type of living object shall be a minimum of adult or child. This can also include an output class label for pets. The class of child can be further divided into an infant, kids less than 3 years old, child between 3 years and 8 years, child between 8 and 12 years and teens. The third classifier 128 can determine whether the detected life is an adult, kid or pet in the respective zone, where the third classifier 128 is invoked only when the previous noise classifiers confidence value is higher than the threshold consistently for the predefined set of frames. This classifier 128 also determines whether the kid is placed on a child restraint system or booster set or none.

The third classifier 128 differentiate the class attributes of the detected living objects e.g., differentiate between adult and infant. The third classifier problem is also non-linear and is simpler if it has to distinguish between adult and infant. Such a classifier can be implemented by a machine learning algorithm that includes, but not limited to, a decision tree or a support vector machine. If it is required to determine more than 2 classes by this third level of classifier, then the problem is highly complex. This complex scenario can also require multiple classifiers in a similar cascaded fashion to determine the different classes of the type of living object.

Based on the noise classifier results, the fourth classifier 130 having similar but separate classifiers for adult and child, are invoked to determine whether they are in appropriate position. The fourth classifier 130 is enabled, when the confidence level of the third classifier 128 is above the threshold value for the predefined set of frames. The fourth classifier 123 determine the position attributes of the detected living objects for a particular size of the living objects in one or more zones within the vehicle, where the position attributes pertaining to any or a combination of desirable position and out-of-position of the living objects within the vehicle. The particular size of the living objects such as adult, child and pet can vary, and the fourth classifier 130 is invoked to determine whether they are in appropriate position. The fourth classifier 130 differentiate between desirable position of the detected living objects from out-of-position of the detected living objects.

For example, the fourth classifier 130 is invoked only if both the noise classifier confidence value is consistently higher than a threshold for a predefined number of frames. The fourth classifier 130 can determine whether the living object is present in the preferable position within the location/zone/seat/region, where they are detected. Unfavourable positions/out-of-position might include, but not limited to, standing on seats, bending forward, lying down on seats, crouching on footwell, kneeling on seats, legs up on the dashboard or other seats. The radar can generate different output for these out-of-position poses based on whether they are adult or child.

Hence, separate classifier models implemented separately for adult and child. As can be appreciated, the present disclosure may not be limited to this configuration but may be extended to other classes that are determined in the third classifier 126.

The fourth output of position classifier 130 is also nonlinear and simple. This classifier state is made simple by considering all the unfavourable positions of the adult/child as a single out-of-position output class of the classifier. Such a classifier can be implemented by a machine learning algorithm that includes, but not limited to, decision trees or support vector machines.

For example, even though all the four classifiers (124 to 130) are tuned to remove noise cases in a cascaded fashion, they inadvertently provide additional information of the environment. The first classifier 124, while removing the false cases provides the negative information of whether the moving object is life. The second classifier 126 while removing the corner cases provides negative information of where the living object is present. The third classifier 128 while classifying adult, provides negative information of child and pet. The fourth classifier 130 while classifying the object in out-of-position provides the negative information of adult or kid being in position. Thus, the life presence output, occupancy status, adult/child/pet classification and out-of-position status can be determined from the four classifiers (124-130). Based on these results, the child left behind status can be determined. For example, if an adult is present in the vehicle, then it is a negative status on the child left behind. The child/pet left behind status shall be positive when only child/children/pet is identified within the vehicle. All the different individual classifier levels are implemented as a machine learning algorithm that includes, but not limited to, a simple decision tree or discriminant analysis, support vector machines, a Neural network or an ensemble of multiple simple classifiers.

The radar-based system 100 as presented in the example is targeted for the child/pet left behind detection application, however, the intermediate output can be used to determine the following features for an in-cabin vehicle use case like life presence detection, seat occupancy detection or occupancy detection, adult vs infant/child detection, passenger classification system, seat belt reminder, airbag deployment system, airbag suppression, airbag low-risk deployment system, auto child lock, vital signs detection, and intrusion detection.

The embodiments of the present disclosure described above provide several advantages. One or more of the embodiments provides the system 100 that can be operated with less power. The present disclosure can cater to various in-cabin features and can break down the complex nonlinear classification problem to a simpler cascaded classification approach without the requirement of a complex deep neural network. System 100 operates on distinguishing the noise, and inadvertently provide information about the environment. The small multiple classifiers resolve smaller problems and hence require less computation and requires less memory. Lesser memory and computation enable the algorithm to be implemented even in a small processor which is a part of an edge embedded system.

Another added advantage of this system 100 is that it provides other intermediate outputs that are part of the small classifier outputs to be used for various other in-cabin use cases and applications. Breaking down the classification problem into smaller classifiers improves the capability to resolve and distinguish noise and false detections. The present disclosure is to provide a system that can be capable to operate under contactless and low ambient light condition. Further, system 100 can be capable to operate even when the living objects are covered by some materials such as a blanket, jacket, sun cover, cloth and the like.

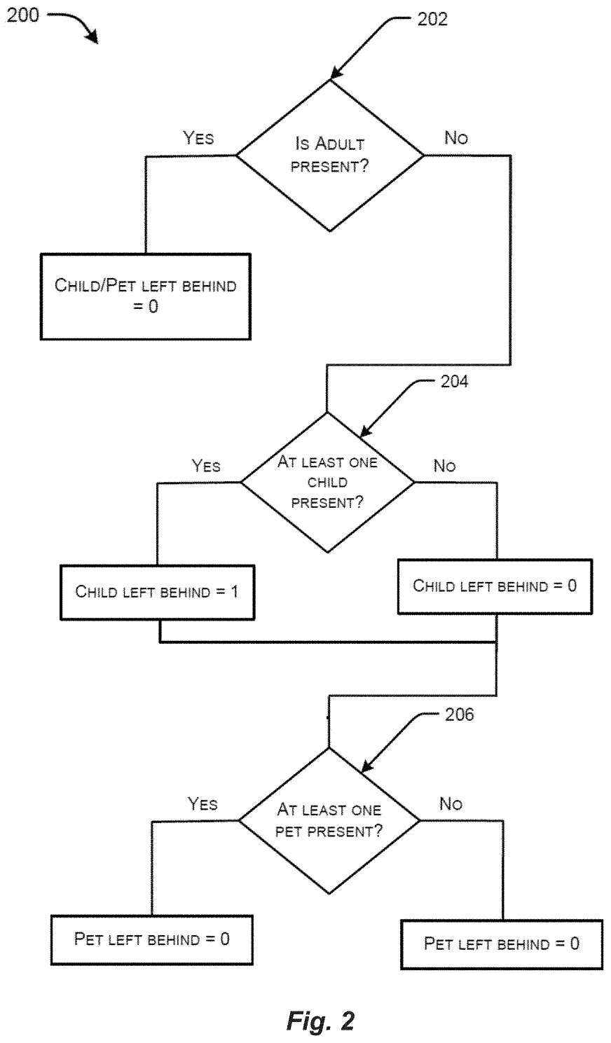

FIG. 2 is an exemplary flow chart illustrating a method(s) 200 to determine the child left behind application in the vehicle, in accordance with an embodiment of the present disclosure.

Referring to FIG. 2, the procedure to determine the child/children/pet left behind is described in the FIG. 2. The child left behind status is defined as the state when a child/children are left in the vehicle unattended beyond a certain period of time. The defined state can include any or a combination of no adult present in the vehicle, multiple children can be present unattended in the vehicle, a pet being left behind in the vehicle and can cover when the child/children/pet is in any position, with/without a child restraint system, booster seat, covered by a blanket, present in the footwell, present in the trunk region and the like. The state can be determined by the information like presence of living objects within the car, which zone/seat is occupied by the living objects and the type of the living objects whether it is an adult or a child or pet.

As illustrated in FIG. 2, at block 202, the classifier 122 can determine whether an adult present in the vehicle, at block 204 classifier 122 can determine whether at least one child present in the vehicle and at block 206, the classifier 122 can determine whether at least one pet present in the vehicle. The negative information about life presence, occupancy status, adult/child/pet classification and in-position status can be obtained from the four classifiers (124 to 130). Based on these results, the child left behind status can be determined as shown in FIG. 2. If an adult is present in the vehicle, then it is a negative status on the child left behind. The child/pet left behind status shall be positive when only child/children/pet is identified within the vehicle.

In an embodiment, FMCW radar system 100 having the signal processing steps of Fast Fourier Transform calculation, removal of static object reflections, and applying the threshold to extract point cloud information. Successively a set of features are extracted from this point cloud information. The features are provided to the first classifier 124, which determines the presence of any life within the vehicle. If any life is detected, then it is passed on to the second classifier 126 to determine the occupancy status. If any of the seat/zone are identified to be occupied then each zone is passed on the third classifier 128 to determine whether the object is a child or an adult. Depending on the result being adult or child, it then passed on the fourth classifier 130 to determine the out-of-position and activity status. Based on the different results of the four classifiers, the child left behind status can be determined.

As proposed in this present disclosure, breaking down the complex problem into multiple classifiers, makes the problem solvable and simple. The present disclosure aims to break down the false cases and corner cases problem into multiple classifiers. This allows the application to be implemented in a small embedded system that can operate very close to one or more sensors 102, where such a system is called an edge embedded processor.

The proposed methodology provides a way to resolve the noise cases individually. The false noise cases like shaking car, water bottle in an empty car can be removed at the first classifier 124. The corner cases of person lying on seat, hand movements, crawling baby or seat bent backwards are handled in the second classifier 126. The third classifier 128 handles the cases between pets, infants and kids and the fourth classifier 130 handles the cases of odd seat positions.

The segregation of the classifiers 122 based on false cases to handle, makes the functionality of each classifier simpler. This also reduces complexity because the current classifier handles only limited cases of noise scenarios. The successive classifier does not have to handle the cases that have already been removed. In addition, each classifier provides additional information about the object that helps in determining the in-cabin environment or the child left behind the scenario.

The cascaded classifier 122 designed for child left behind detection, can still be used based on its intermediate outputs to perform all the radar based in-vehicle applications which include, but not limited to, life presence detection, seat occupancy detection, adult vs child classification, passenger classification system, out of position, automatic child lock, intrusion detection, seat belt remainder, air bag deployment, air bag suppression, and air bag low risk deployment.

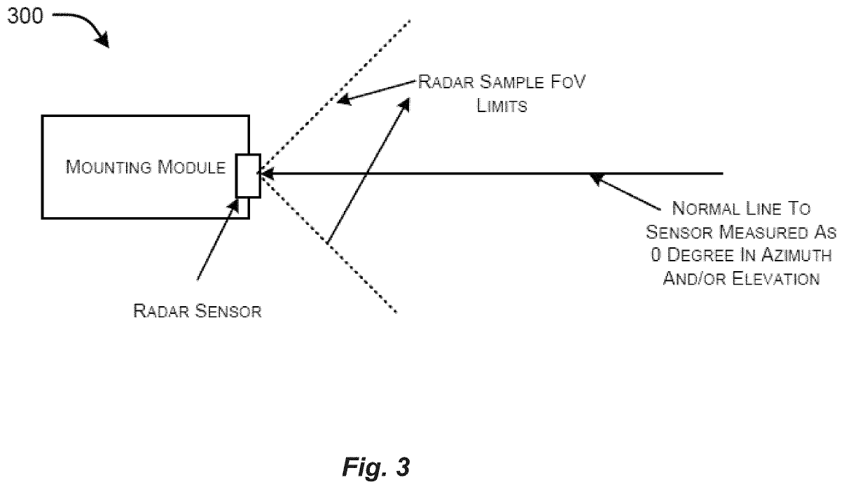

FIG. 3 illustrates an exemplary top view of the antenna averaged data 300 at a zero degree angle, in accordance with an embodiment of the present disclosure.

As shown in FIG. 3, the input data may be collected using FMCW radar with any or a combination of single waveform pattern and multiple waveform patterns. The intermediate frequency signal may include range, velocity and bearing angle information about the reflected object 104, where the received intermediate signal may include information from multiple reflections from the objects 104 in the FOV of one or more sensors 102. The distance of object 104 from the radar and the relative velocity of object 104 may be determined by the peaks in the 2D FFT of the input data, where the first dimension refers to the direction along the ADC samples within the chirp (also referred to as range direction) and the second dimension refers to the direction along the chirps (also referred to as velocity direction).

The 2D FFT may be processed across the samples in the chirp to process any or a combination of range information and velocity/doppler information, where a predefined threshold value (thresholding technique) may be used to detect the prominent reflection points in the received digital set of signals. The DoA algorithm may be used to estimate the bearing angle of the detected prominent reflection points. A grouping mechanism also interchangeably referred to as grouping unit may group the detected prominent reflection points based on the position with the region of interest within the vehicle and with respect to the mounted sensor. The resultant of all these signal processing may generate the point cloud dataset/list having details of the prominent reflection points, where the point cloud dataset may include the information about the range, angle (azimuth and/or elevation), velocity and/or reflected power of the targets, where the targets may include any or a combination of adult, children, baby, empty seats and other objects 104 inside the car that is within the FoV of the one or more sensors 102.

In an embodiment, the present disclosure can be used for the FMCW radar with a minimum of one transmitter antenna and one receiver antenna. In another embodiment, the FMCW radar with one or more transmitter and/or receiver antenna may have object bearing angle related phase information across the antenna, where the third dimension refers to the object bearing angle related phase information across the antenna.

The FMCW radar with one or more transmitter and/or receiver antenna may have an object bearing angle related phase information across the antenna. The one or more transmitter and receiver antennas can be arranged only in one direction either azimuth or elevation or/and in both azimuth and elevation direction. To determine the bearing angle of object 104 in both azimuth and/or elevation, as subtended from the objects 104 on the normal line, the 2D FFT may determine the bearing angle in azimuth and elevation. Other DoA estimation algorithms like barlett, Capon/MvDR, MUSIC. ESPRIT or Matrix Pencil can be used for better accuracy and resolution with higher computation cost. The present disclosure is independent of the selected DoA algorithm.

The present disclosure describes the signal processing chain, but not limited to, with range and velocity estimation followed by the threshold process and then a direction of arrival estimation. The present disclosure is not limited to this signal processing chain and can be possible to work on other signal processing chains like having range and velocity estimation and followed by angle estimation (azimuth and/or elevation) and then thresholding to detect prominent reflection points. Another possible signal processing chain can be to have the range and bearing angle estimation followed by thresholding and then velocity estimation. The resultant of all these signal processing pipelines can be the point cloud list having details of the prominent reflection points and their information like position range, angle, velocity and power. The proposed disclosure can work with any signal processing pipeline that provides a point cloud list or object list which has information on the prominent peaks or reflections from the target objects.

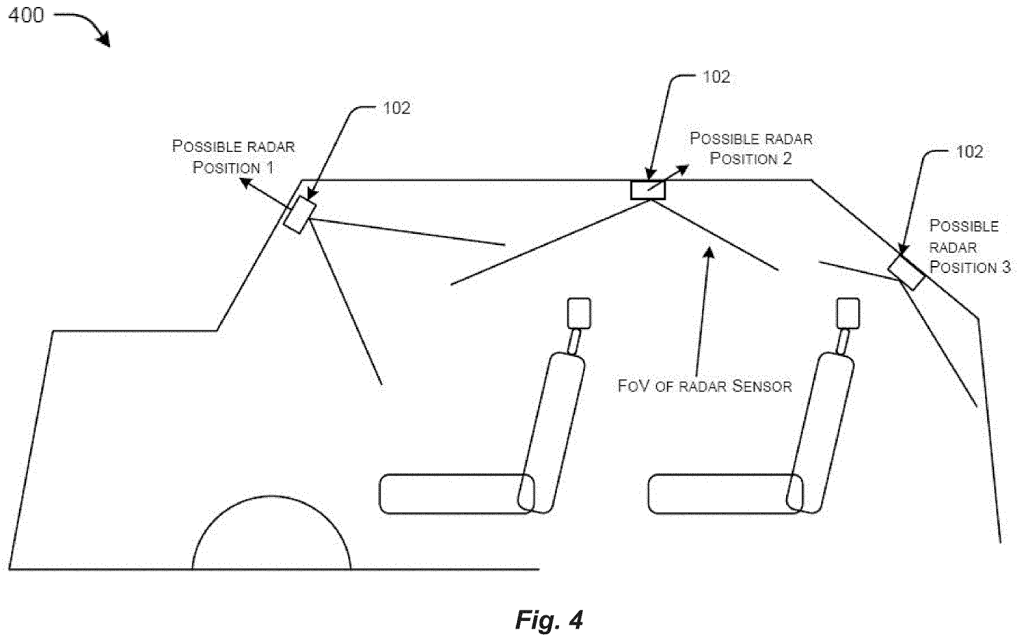

FIG. 4 illustrates an exemplary view of the radar mounting position 400 within the vehicle, in accordance with an embodiment of the present disclosure. The present disclosure can operate in three sample positions as shown in FIG. 4. One or more sensors 102 mounted inside the vehicle with its RF emitting direction pointing towards the interior of the vehicle, for example, the one or more sensors 102 mounted in a front portion, a top portion and a rear portion within the vehicle. The system 100 of the present disclosure tuned to operate the one or more sensors 102 placed at any position as long as the FOV of the one or more sensors 102 covers the required region of interest. The present disclosure may be extensively used in all automotive such as passenger cars, trucks, buses and the like.

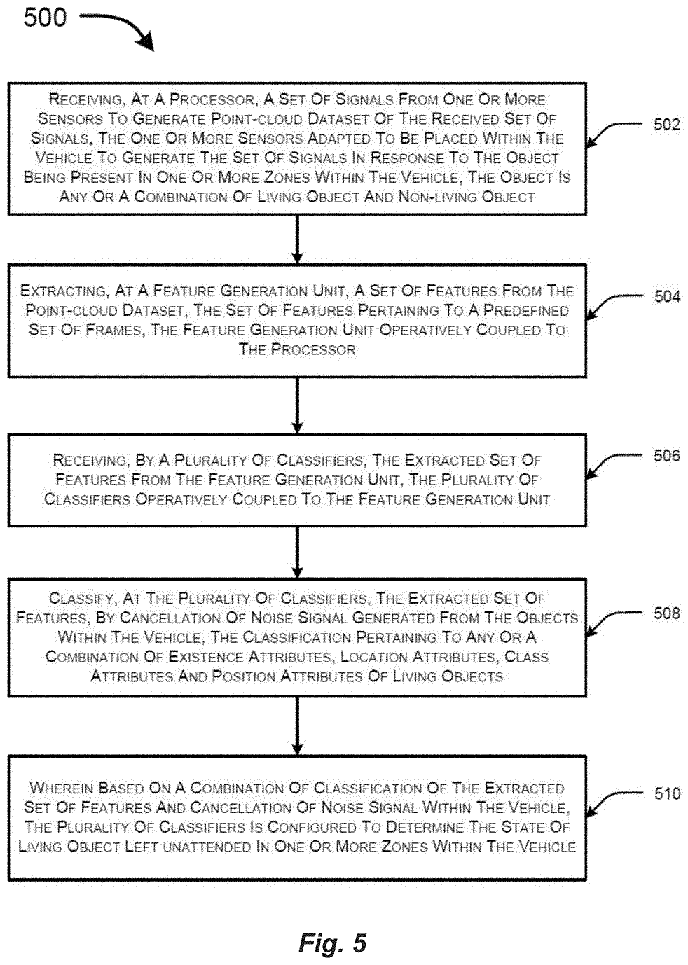

FIG. 5 illustrates an exemplary flow diagram of a method(s) 500 for determining occupancy state of objects within the vehicle, in accordance with an embodiment of the present disclosure.

Referring to FIG. 5, at block 502, the processor 106 can received a set of signals from one or more sensors 102 to generate a point-cloud dataset of the received set of signals, the one or more sensors 102 adapted to be placed within the vehicle to generate the set of signals in response to the objects 104 being present in one or more zones within the vehicle, the objects can be any or a combination of living objects and non-living objects.

At block 504, the feature generation unit 120 extracts a set of features from the point-cloud dataset, the set of features pertaining to a predefined set of frames, the feature generation unit operatively coupled to the processor 106. At block 506, the plurality of classifiers 122 receive the extracted set of features from the feature generation unit 120, the plurality of classifiers 122 operatively coupled to the feature generation unit.

At block 508, the plurality of classifiers 122 classify the extracted set of features by cancellation of noise signal generated from the objects within the vehicle, the classification pertaining to any or a combination of existence attributes, occupancy attributes, class attributes and position attributes of living objects. At block 510, based on a combination of classification of the extracted set of features and cancellation of noise signal within the vehicle, the plurality of classifiers 122 is configured to determine the occupancy state of living object left unattended in one or more zones within the vehicle.

It will be apparent to those skilled in the art that the system 100 of the disclosure may be provided using some or all of the mentioned features and components without departing from the scope of the present disclosure. While various embodiments of the present disclosure have been illustrated and described herein, it will be clear that the disclosure is not limited to these embodiments only. Numerous modifications, changes, variations, substitutions, and equivalents will be apparent to those skilled in the art, without departing from the spirit and scope of the disclosure, as described in the claims.

### Advantages of the Present Disclosure

The present disclosure provides a system that can cater various in-cabin features

The present disclosure provides a system that can that can break down the complex nonlinear classification problem to a simpler cascaded classification approach, which thereby reduce the requirement of complex deep neural network.

The present disclosure provides a system that operates on distinguishing the noise, false detections and inadvertently provide information about the environment by reliably detecting a child/children/pet left behind anywhere in the whole vehicle.

The present disclosure provides a system that requires less power, computation and memory.

The present disclosure provides a system that can use at least one sensor to cover more than one seat/location, with a minimum of one sensor per seat to a maximum of one sensor per whole car covering two rows, five seats, footwell and truck region

The present disclosure provides a system that can be extended to larger vehicles like 6/7/8 seaters by increasing the field of view of the sensor and/or by adding additional sensors of same type.

The present disclosure ensures faster response time of less than a second, when compared to other existing radar-based approaches that use vital signs for occupancy detection

The present disclosure provides a system that can be capable to operate under contactless and low ambient light condition.

The present disclosure provides a system that can be capable to operate even when the living objects are covered by some materials such as blanket, jacket, sun cover, cloth and the like.

We claim:

1. A system (100) for determining occupancy state of objects in a vehicle, said system comprising:
one or more sensors (102) adapted to be placed within the vehicle to generate a set of signals in response to the objects being present in one or more zones within the vehicle, the objects are any or a combination of living objects and non-living objects;
a processor (106) operatively coupled to the one or more sensors (102), the processor (106) configured to process the received set of signals to generate a point-cloud dataset of the received set of signals;
a feature generation unit (120) operatively coupled to the processor, the feature generation unit extract a set of features from the point-cloud dataset, the set of features pertaining to a predefined set of frames; and
a plurality of classifiers (122) operatively coupled to the feature generation unit, the plurality of classifiers configured to:
receive, from the feature generation unit (120), the extracted set of features; and
classify the extracted set of features by cancellation of noise signal generated from the objects within the vehicle, the classification pertaining to any or a combination of existence attributes, occupancy attributes, class attributes and position attributes of living objects, wherein based on a combination of classification of the extracted set of features and cancellation of noise signal within the vehicle, the plurality of classifiers (122) is configured to determine the occupancy state of living objects left unattended in one or more zones within the vehicle.

2. The system as claimed in claim 1, wherein the plurality of classifiers (122) comprises a first classifier (124), a second classifier (126), a third classifier (128) and a fourth classifier (130).

3. The system as claimed in claim 2, wherein the first classifier (124) of the plurality of classifiers (122) determines the existence attributes of living object within the vehicle by cancellation of the noise signal generated by the non-living objects within the vehicle, the first classifier (124) differentiates between the living objects and the non-living objects.

4. The system as claimed in claim 2, wherein the second classifier (126) of the plurality of classifiers (122) is enabled when a confidence level of the first classifier (124) is above a threshold value for the predefined set of frames, wherein the second classifier (124) cancels the noise signal generated by motion of the living objects within the vehicle and determines the occupancy attributes of the detected living objects in one or more zones within the vehicle.

5. The system as claimed in claim 4, wherein the second classifier (126) of the plurality of classifiers determines the total number of living objects located in one or more zones within the vehicle, the second classifier (126) differentiates between the motion of living objects and the detected living objects.

6. The system as claimed in claim 2, wherein the third classifier (128) of the plurality of classifiers (122) is enabled, when the confidence level of each of the first classifier (124) and the second classifier (126) is above the threshold value for the predefined set of frames, wherein the third classifier (128), on receipt of an enable signal, configured to determine the class attributes of the detected living objects in respective zone of the one or more zones within the vehicle, the third classifier (128) differentiate the class attributes of the detected living objects.

7. The system as claimed in claim 2, wherein the fourth classifier (130) of the plurality of classifiers (122) is enabled, when the confidence level of the third classifier (128) is above the threshold value for the predefined set of frames, wherein the fourth classifier (130) determine the position attributes of the detected living objects for a particular size of the living objects in one or more zones within the vehicle, the position attributes pertaining to any or a combination of desirable position and out-of-position of the living objects within the vehicle.

8. The system as claimed in claim 7, wherein the combination results of the plurality of classifiers (122) are employed individually or in a group for the different in-cabin applications.

9. The system as claimed in claim 1, wherein the occupancy state of living objects left unattended in one or more zones within the vehicle are any or a combination of child, infant and pet.

10. A method (500) for determining occupancy state of objects in a vehicle, said method comprising
receiving (502), at a processor, a set of signals from one or more sensors to generate a point-cloud dataset of the received set of signals, the one or more sensors adapted to be placed within the vehicle to generate the set of signals in response to the objects being present in one or more zones within the vehicle, the objects are any or a combination of living object and non-living object;
extracting (504), at a feature generation unit, a set of features from the point-cloud dataset, the set of features pertaining to a predefined set of frames, the feature generation unit operatively coupled to the processor;
receiving (506), by a plurality of classifiers, the extracted set of features from the feature generation unit, the plurality of classifiers operatively coupled to the feature generation unit; and
classifying (508), at the plurality of classifiers, the extracted set of features by cancellation of noise signal generated from the objects within the vehicle, the classification pertaining to any or a combination of existence attributes, occupancy attributes, class attributes and position attributes of the living objects, wherein based on a combination of classification of the extracted set of features and cancellation of noise signal within the vehicle, the plurality of classifiers is configured to determine (510) the occupancy state of living object left unattended in one or more zones within the vehicle.
